(19) United States
(12) Patent Application Publication
(10) Pub. No.: US 2017/0170712 A1
(43) Pub. Date: Jun. 15, 2017

(54) VIBRATION MOTOR

(71) Applicant: Nidec Corporation, Kyoto (JP)

(72) Inventors: Takeru OMURA, Kyoto (JP); Imari MATSUBARA, Kyoto (JP)

(21) Appl. No.: 15/374,003

(22) Filed: Dec. 9, 2016

(30) Foreign Application Priority Data
Dec. 11, 2015 (JP) 2015-242650

(51) Int. Cl. H02K 33/02; H02K 1/12; H02K 15/00; H02K 1/34

(52) U.S. Cl. CPC H02K 33/02; H02K 1/34; H02K 1/12; H02K 15/00

(57) ABSTRACT

A vibration motor includes a stationary portion including a casing and a coil; a vibrator including a magnet, and supported to be capable of vibrating in a first direction with respect to the stationary portion; and an elastic member arranged between the stationary portion and the vibrator. The elastic member includes an increased thickness portion including a fixed surface fixed to one of the vibrator and the stationary portion; a decreased thickness portion having a thickness smaller than that of the increased thickness portion as measured in the first direction; and a connection portion arranged between the increased thickness portion and the decreased thickness portion in a second direction perpendicular to the first direction. The connection portion is arranged to have a thickness smaller than that of the increased thickness portion and greater than that of the decreased thickness portion.

### CROSS REFERENCE TO RELATED APPLICATIONS

This application claims the benefit of priority to Japanese Patent Application No. 2015-242650 filed on Dec. 11, 2015. The entire contents of this application are hereby incorporated herein by reference.

### BACKGROUND OF THE INVENTION

1. Field of the Invention

The present invention relates to a vibration motor.

2. Description of the Related Art

Vibration motors arranged to produce haptic feedback are installed in various types of devices, such as, for example, smartphones. Such a vibration motor includes a vibrator including a magnet, and a coil fixed to a casing. Once the vibration motor is driven, a magnetic field is generated between the magnet and the coil, so that the vibrator is caused to vibrate.

The vibration motor as described above includes a plate spring portion arranged to support the vibrator such that the vibrator is capable of vibrating in one direction. An end portion of the plate spring portion is typically fixed to a side surface of the vibrator through welding. In this case, however, if the vibration motor operates continuously or if a fall of the vibration motor occurs, a stress may be concentrated on a weld portion of the plate spring portion, resulting in a rupture of the weld portion.

Accordingly, in a vibration motor described in CN 102340229A, for example, a plate spring portion is fixed to a vibrator, and a reinforcing plate is fixed to the plate spring portion. This arrangement causes a base point of a deformation of the plate spring portion to shift from a weld portion to a boundary between the reinforcing plate and the plate spring portion, resulting in a reduction in a stress concentrated on the weld portion.

However, the vibration motor described in CN 102340229A involves an abrupt change in a thickness at the boundary between the reinforcing plate and the plate spring portion, resulting in an abrupt reduction in rigidity of the plate spring portion. Moreover, a stress is concentrated on the boundary. Therefore, vibration of the vibration motor or the like may cause a rupture of the plate spring portion at the boundary.

### SUMMARY OF THE INVENTION

A vibration motor according to a preferred embodiment of the present invention includes a stationary portion including a casing and a coil; a vibrator including a magnet, and supported to be capable of vibrating in a first direction with respect to the stationary portion; and an elastic member arranged between the stationary portion and the vibrator. The elastic member includes an increased thickness portion including a fixed surface fixed to one of the vibrator and the stationary portion; a decreased thickness portion having a thickness smaller than that of the increased thickness portion as measured in the first direction; and a connection portion arranged between the increased thickness portion and the decreased thickness portion in a second direction perpendicular to the first direction. The connection portion is arranged to have a thickness smaller than that of the increased thickness portion and greater than that of the decreased thickness portion.

The vibration motor according to a preferred embodiment of the present invention is able to reduce the possibility that vibration of the vibrator or the like will cause a rupture of the elastic member.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an exploded perspective view of a vibration motor according to a first preferred embodiment of the present invention.

FIG. 2 is an enlarged perspective view illustrating a portion of an elastic member which is fixed to a vibrator according to the first preferred embodiment of the present invention.

FIG. 3 is a diagram illustrating an example distribution of hardness of a beam portion along a second direction as a result of welding according to the first preferred embodiment of the present invention.

FIG. 4 is an enlarged perspective view illustrating portions of the elastic member including a portion thereof fixed to a cover according to the first preferred embodiment of the present invention.

FIG. 5 is an enlarged perspective view illustrating a portion of an elastic member according to a second preferred embodiment of the present invention which is fixed to a vibrator.

FIG. 6 is an enlarged perspective view illustrating a portion of an elastic member according to a third preferred embodiment of the present invention which is fixed to a vibrator.

FIG. 7 is an enlarged perspective view illustrating a portion of an elastic member according to a fourth preferred embodiment of the present invention which is fixed to a vibrator.

### DETAILED DESCRIPTION OF THE PREFERRED EMBODIMENTS

### 1. First Preferred Embodiment

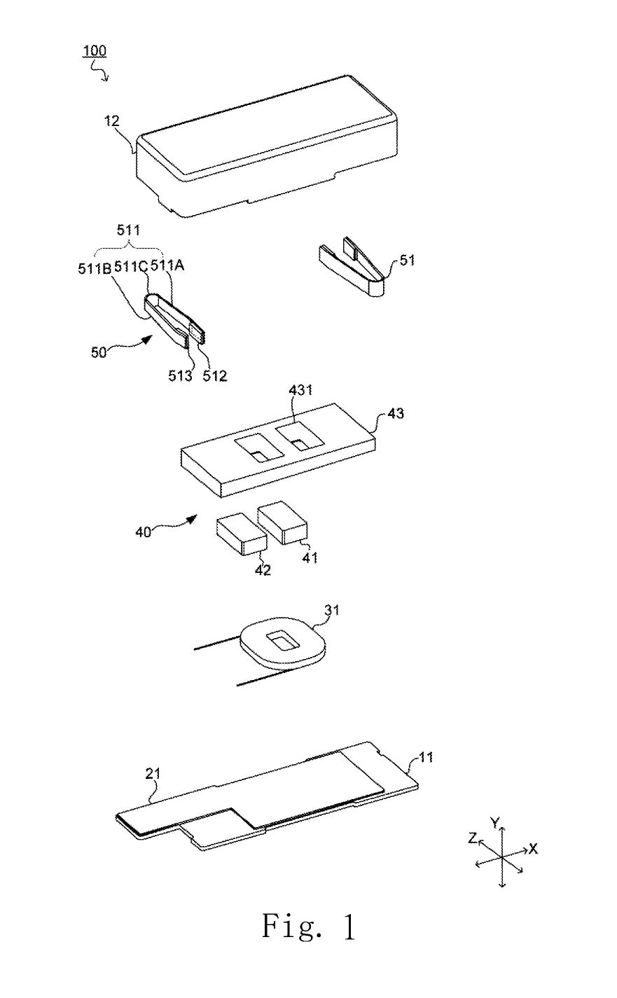

Hereinafter, exemplary preferred embodiments of the present invention will be described with reference to the accompanying drawings. FIG. 1 is an exploded perspective view of a vibration motor according to a first preferred embodiment of the present invention.

In FIG. 1, a right-left direction is defined as a first direction, which is denoted as an X direction. In addition, a vertical direction, which is a direction perpendicular to the first direction, is denoted as a Y direction. For example, the upper side in FIG. 1 is the upper side in the vertical direction (i.e., the Y direction). In addition, a second direction, which is perpendicular to both the first direction and the vertical direction, is denoted as a Z direction. The same is true of other drawings to which reference will be made below. It should be noted, however, that the above definitions of the directions are not meant to restrict in any way the orientation of a vibration motor according to any preferred embodiment of the present invention.

### 1.1 Overall Structure

A vibration motor 100 according to the present preferred embodiment includes a base plate 11, a board 21, a coil 31, a vibrator 40, an elastic member 50, an elastic member 51, and a cover 12. The vibration motor 100 includes a casing including the base plate 11 and the cover 12.

The board 21 is defined by a rigid board, a flexible board, or the like, and is fixed to an upper surface of the base plate 11. The coil 31 is attached to an upper surface of the board 21. The coil 31 is adhered to the board 21 through an adhesive, for example. Note that the coil 31 may alternatively be fixed to the board 21 by a method other than adhesion.

A stationary portion of the vibration motor 100 is made up of the casing, the board 21, and the coil 31. That is, the vibration motor 100 includes a stationary portion including the casing and the coil 31.

The vibrator 40 includes a plurality of magnets 41 and 42 and a weight 43 in the shape of a rectangular parallelepiped. In the present preferred embodiment, the number of magnets 41 and 42 is two. The weight 43 is in the shape of a rectangular parallelepiped, and includes cavity portions 431. Each cavity portion 431 is arranged to pass through the weight 43 in an axial direction. The number of cavity portions 431 is two, and the two cavity portions 431 are arranged in the first direction. Each of the magnets 41 and 42 is accommodated in a separate one of the cavity portions 431. The magnets 41 and 42 are thus held by the weight 43. The magnets 41 and 42 are arranged on the upper side of the coil 31. Note that each cavity portion 431 may not pass through the weight 43 in the axial direction, and may alternatively be a recessed portion in which a corresponding one of the magnets 41 and 42 can be accommodated.

The elastic member 50 includes a plate spring portion 511, a reinforcing plate 512, and a reinforcing plate 513. The plate spring portion 511 includes a beam portion 511A, a beam portion 511B, and a joining portion 511C. The beam portions 511A and 511B, each of which is in the shape of a plate, are arranged opposite to each other in the first direction. The joining portion 511C is arranged to join an end portion of the beam portion 511A and an end portion of the beam portion 511B to each other.

An end portion of the beam portion 511A on a side opposite to the joining portion 511C and an end portion of the beam portion 511B on a side opposite to the joining portion 511C are arranged to bend so as to become closer to each other in the first direction. This end portion of the beam portion 511A is fixed to a side surface of the weight 43 which extends in the second direction, and is also fixed to the reinforcing plate 512. This end portion of the beam portion 511B is fixed to an inner wall surface of the cover 12, and is also fixed to the reinforcing plate 513. That is, one end portion of the elastic member 50 is fixed to the weight 43, while another end portion of the elastic member 50 is fixed to the inner wall surface of the cover 12. That is, the elastic member 50 is arranged between the stationary portion and the vibrator 40. The structure of the elastic member 50 will be described in more detail below.

The elastic member 51 has a structure similar to that of the elastic member 50. One end portion of the elastic member 51 is fixed to a side surface of the weight 43 which extends in the second direction. The one end portion of the elastic member 51 is arranged diagonally opposite to the one end portion of the elastic member 50 fixed to the weight 43. Another end portion of the elastic member 51 is fixed to the inner wall surface of the cover 12. As a result, the vibrator 40 is supported by the elastic members 50 and 51 such that the vibrator 40 is capable of vibrating in the first direction (i.e., the X direction) with respect to the stationary portion. A portion of the board 21, the coil 31, the vibrator 40, and the elastic members 50 and 51 are accommodated in an interior space defined by the cover 12 and the base plate 11.

In the vibration motor 100 having the above-described structure, an electric current is supplied to the coil 31 through a wiring on the board 21. Once the electric current passes through the coil 31, a magnetic field generated around the coil 31 interacts with magnetic fields generated by the magnets 41 and 42 to cause reciprocating vibration of the vibrator 40 in the first direction.

### 1.2 Detailed Structure of Elastic Member

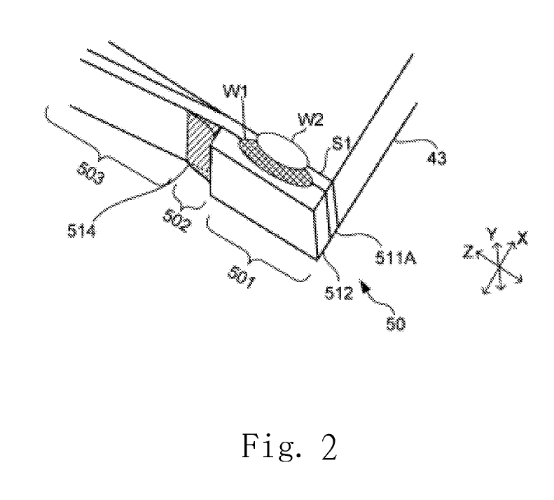

Next, the structure of the elastic member 50 will now be described in detail below. FIG. 2 is an enlarged perspective view illustrating a portion of the elastic member 50 which is fixed to the vibrator 40.

The elastic member 50 includes an increased thickness portion 501, a connection portion 502, and a decreased thickness portion 503. An end portion of the beam portion 511A of the plate spring portion 511 includes a fixed surface S1 fixed to the side surface of the weight 43 of the vibrator 40 which extends in the second direction. The reinforcing plate 512 is fixed to a surface of the end portion of the beam portion 511A on a side opposite to the fixed surface S1 in the first direction. The increased thickness portion 501 is made up of the end portion of the beam portion 511A which includes the fixed surface S1, and the reinforcing plate 512. That is, the increased thickness portion 501 includes the fixed surface S1 fixed to the vibrator 40.

The decreased thickness portion 503 is arranged to have a thickness smaller than the thickness of the increased thickness portion 501 as measured in the first direction. The decreased thickness portion 503 is a portion of the beam portion 511A. The connection portion 502 is arranged between the increased thickness portion 501 and the decreased thickness portion 503 in the second direction.

The connection portion 502 is made up of an adhesive 514 and a portion of the beam portion 511A. This portion of the beam portion 511A is arranged between the portion of the beam portion 511A which defines the decreased thickness portion 503 and the end portion of the beam portion 511A which defines a portion of the increased thickness portion 501 in the second direction. The adhesive 514 is applied onto the above portion of the beam portion 511A, and is attached to a side surface of the reinforcing plate 512 which extends in the first direction.

A surface of the adhesive 514 is defined in the connection portion 502 as a result of the application of the adhesive 514. As a result, the thickness of the connection portion 502 as measured in the first direction is smaller than that of the increased thickness portion 501 and greater than that of the decreased thickness portion 503. In the case where the elastic member involves an abrupt decrease in a thickness between the increased thickness portion and the decreased thickness portion as in related art, a stress may be concentrated on a boundary between the increased thickness portion and the decreased thickness portion, which may result in a rupture of the elastic member. In contrast, in the present preferred embodiment, the connection portion 502 serves to distribute a stress over an area extending over the increased thickness portion 501, the connection portion 502, and the decreased thickness portion 503. This contributes to preventing a rupture of the elastic member 50 on the side on which the elastic member 50 is fixed to the vibrator 40 while the vibrator is normally vibrating or in the event of a fall of the vibration motor 100, for example.

In the present preferred embodiment, the connection portion 502 is arranged to decrease in a thickness as measured in the first direction toward the decreased thickness portion 503 away from the increased thickness portion 501. This contributes to a better distribution of a stress applied to a boundary between the increased thickness portion 501 and the connection portion 502. In the case where, when the adhesive 514 is applied, a portion of the adhesive 514 enters into a gap between the reinforcing plate 512 and the beam portion 511A, strength with which the reinforcing plate 512 is fixed to the beam portion 511A is increased.

Next, a method by which the plate spring portion 511, the reinforcing plate 512, and the vibrator 40 are fixed to one another will now be described below. First, a laser spot covering a portion of an upper surface of the end portion of the beam portion 511A and a portion of an upper surface of the reinforcing plate 512 is irradiated to perform spot welding. As a result, an internal portion of the beam portion 511A and an internal portion of the reinforcing plate 512 are fused to define a weld portion made up of a first welding mark W1 on a surface and an internal fused portion (not shown). The reinforcing plate 512 is fixed to the beam portion 511A through this weld portion.

Next, a laser spot covering a portion of the upper surface of the end portion of the beam portion 511A and a portion of an upper surface of the weight 43 is irradiated to perform spot welding. As a result, an internal portion of the beam portion 511A and an internal portion of the weight 43 are fused to define a weld portion made up of a second welding mark W2 on a surface and an internal fused portion (not shown). The beam portion 511A is fixed to the weight 43 through this weld portion.

As a result, a weld portion extending over the reinforcing plate 512, the plate spring portion 511, and the vibrator 40 is defined. That is, the weld portion is defined in the vibrator 40 and the increased thickness portion 501. When welding is used for fixing, the fixing strength is increased.

It is desirable that not only the laser spots on the upper surfaces of the reinforcing plate 512, the beam portion 511A, and the weight 43, but also laser spots on lower surfaces of the reinforcing plate 512, the beam portion 511A, and the weight 43 be irradiated to perform spot welding. Note that a laser spot covering portions of the upper surfaces of the reinforcing plate 512, the beam portion 511A, and the weight 43 may alternatively be irradiated to perform welding. This allows the reinforcing plate 512, the beam portion 511A, and the vibrator 40 to be fixed to one another at once without the welding process being divided into two separate welding processes, resulting in a reduced number of processes for assembling the vibration motor 100.

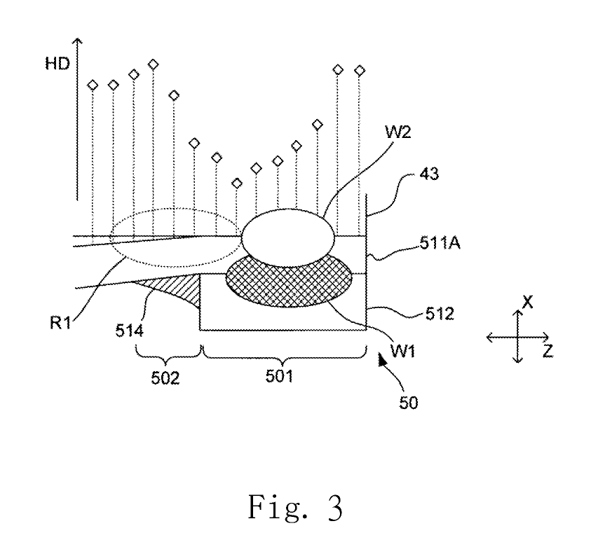

Here, FIG. 3 is a diagram illustrating an example distribution of hardness HD of the beam portion 511A along the second direction as a result of the welding. As illustrated in FIG. 3, the elastic member 50 has a first region R1 adjacent to the second welding mark W2 in the second direction. That is, the first region R1 is adjacent to the weld portion in the second direction.

The connection portion 502 is arranged opposite to the first region R1 in the first direction. The connection portion 502 is thus arranged to overlap with a portion of the beam portion 511A which is in the vicinity of the weld portion and at which the hardness HD increases, so that the portion of the beam portion 511A at which a rupture tends to easily occur because of the increase in the hardness HD can be reinforced, and a concentrated stress can be distributed. The possibility of a rupture of the elastic member 50 is accordingly reduced.

The first region R1 may be a region in the shape of an ellipse and having a major axis having the same length as that of a major axis of the second welding mark W2, which is in the shape of an ellipse. Note that, in the case where the welding mark is circular, the first region R1 may be circular and have the same diameter as that of the welding mark, and in the case where the welding mark is rectangular, the first region R1 may be rectangular and have a side having the same length as that of one side of the welding mark.

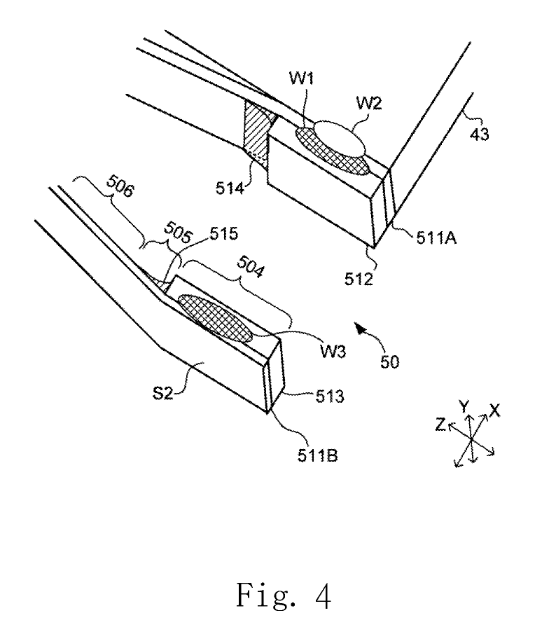

FIG. 4 is an enlarged perspective view illustrating portions of the elastic member 50 including a portion thereof fixed to the cover 12. The structure of the elastic member 50 on the side on which the elastic member 50 is fixed to the cover 12 is substantially similar to the structure of the elastic member 50 on the side on which the elastic member 50 is fixed to the vibrator 40 described above, and therefore, redundant description will be omitted.

An end portion of the beam portion 511B, which is included in the plate spring portion 511, includes a fixed surface S2 fixed to the cover 12. The reinforcing plate 513 is fixed to a surface of this end portion of the beam portion 511B on a side opposite to the fixed surface S2 in the first direction. An increased thickness portion 504 is made up of the above end portion of the beam portion 511B and the reinforcing plate 513.

A decreased thickness portion 506, which is a portion of the beam portion 511B, is arranged to have a thickness smaller than the thickness of the increased thickness portion 504 as measured in the first direction. A connection portion 505 is arranged between the increased thickness portion 504 and the decreased thickness portion 506 in the second direction. The connection portion 505 is made up of a portion of the beam portion 511B and an adhesive 515 applied thereto. The thickness of the connection portion 505 as measured in the first direction is smaller than that of the increased thickness portion 504 and greater than that of the decreased thickness portion 506. The connection portion 505 serves to distribute a stress over an area extending over the increased thickness portion 504, the connection portion 505, and the decreased thickness portion 506. This contributes to preventing a rupture of the elastic member 50 on the side on which the elastic member 50 is fixed to the cover 12 while the vibrator 40 is normally vibrating or in the event of a fall of the vibration motor 100, for example.

The reinforcing plate 513 is fixed to the beam portion 511B by spot welding, and a first welding mark W3 extending over a portion of an upper surface of the beam portion 511B and a portion of an upper surface of the reinforcing plate 513 is defined. In addition, the beam portion 511B is fixed to the inner wall surface of the cover 12 by spot welding, and a second welding mark (not shown) extending over a portion of the upper surface of the beam portion 511B and a portion of the inner wall surface of the cover 12 is defined. As a result, a weld portion extending over the reinforcing plate 513, the plate spring portion 511, and the stationary portion is defined. That is, the weld portion is defined in the stationary portion and the increased thickness portion 504. Note that a laser spot covering portions of the cover 12, the beam portion 511B, and the reinforcing plate 513 may alternatively be irradiated to accomplish the spot welding at once.

The connection portion 505 is arranged opposite, in the first direction, to a first region adjacent to the weld portion in the second direction, as is similarly the case with the connection portion 502 as described above with reference to FIG. 3. The connection portion 505 is thus arranged at a position at which the hardness of the beam portion 511B has increased as a result of the welding, which leads to a reduction in the possibility of a rupture of the elastic member 50.

### 2. Second Preferred Embodiment

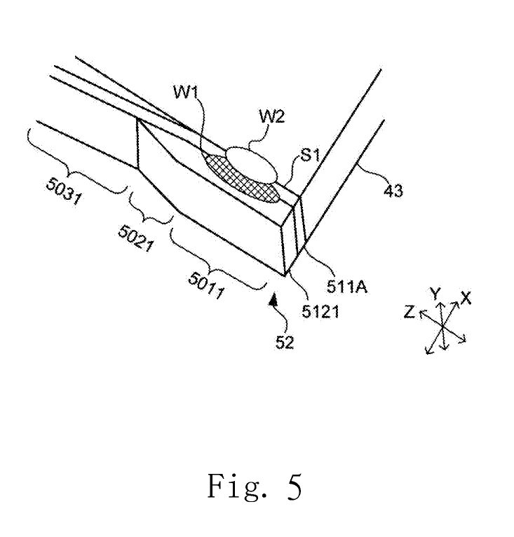

Next, a second preferred embodiment of the present invention will now be described below. FIG. 5 is an enlarged perspective view illustrating a portion of an elastic member 52 according to the second preferred embodiment which is fixed to a vibrator 40.

The elastic member 52 includes an increased thickness portion 5011, a connection portion 5021, and a decreased thickness portion 5031. The increased thickness portion 5011 is made up of an end portion of a beam portion 511A which includes a fixed surface S1, and a portion of a reinforcing plate 5121. The connection portion 5021 is made up of a portion of the beam portion 511A and a portion of the reinforcing plate 5121. That is, the reinforcing plate 5121 defines not only a portion of the increased thickness portion 5011 but also a portion of the connection portion 5021. The thickness of the connection portion 5021 as measured in the first direction is arranged to gradually increase toward the increased thickness portion 5011 in the second direction. The thickness of a portion of the connection portion 5021 which is joined to the increased thickness portion 5011 as measured in the first direction is equal to the thickness of the increased thickness portion 5011 as measured in the first direction. An upper surface of the connection portion 5021 is preferably arranged to be flush with an upper surface of the increased thickness portion 5011.

Thus, the need for an application of an adhesive, which is necessary in the first preferred embodiment, to define the connection portion is eliminated, and the number of steps for assembling a vibration motor according to the present preferred embodiment and the number of parts of the vibration motor can be reduced.

### 3. Third Preferred Embodiment

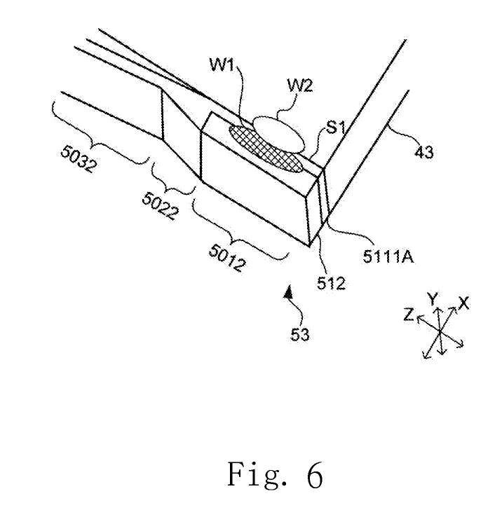

Next, a third preferred embodiment of the present invention will now be described below. FIG. 6 is an enlarged perspective view illustrating a portion of an elastic member 53 according to the third preferred embodiment which is fixed to a vibrator 40.

The elastic member 53 includes an increased thickness portion 5012, a connection portion 5022, and a decreased thickness portion 5032. The increased thickness portion 5012 is made up of an end portion of a beam portion 5111A which includes a fixed surface S1, and a reinforcing plate 512. The connection portion 5022 is defined by a portion of the beam portion 5111A. A side surface of the connection portion 5022 which faces in the second direction is arranged to be in contact with a side surface of the reinforcing plate 512 which faces in the second direction. The reinforcing plate 512 is thus positioned in the second direction with respect to the beam portion 5111A. The reinforcing plate 512 is fixed to the beam portion 5111A, which includes the connection portion 5022, through adhesion, welding, or the like. An upper surface of the connection portion 5022 is preferably arranged to be flush with an upper surface of the increased thickness portion 5012.

Also in the present preferred embodiment, the need for an application of an adhesive, which is necessary in the first preferred embodiment, to define the connection portion is eliminated, and the number of steps for assembling a vibration motor according to the present preferred embodiment and the number of parts of the vibration motor can be reduced.

### 4. Fourth Preferred Embodiment

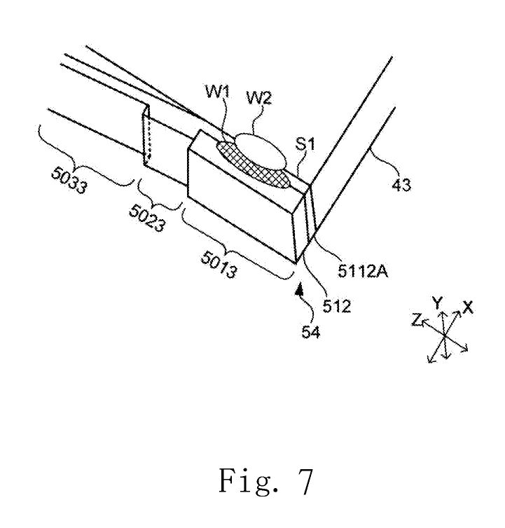

Next, a fourth preferred embodiment of the present invention will now be described below. FIG. 7 is an enlarged perspective view illustrating a portion of an elastic member 54 according to the fourth preferred embodiment which is fixed to a vibrator 40.

The elastic member 54 includes an increased thickness portion 5013, a connection portion 5023, and a decreased thickness portion 5033. In the present preferred embodiment, as well as in the third preferred embodiment, the connection portion 5023 is defined by a portion of a beam portion 5112A. The connection portion 5022 according to the third preferred embodiment is arranged to decrease in a thickness toward the decreased thickness portion 5032 away from the increased thickness portion 5012. In contrast, the thickness of the connection portion 5023 according to the present preferred embodiment as measured in the first direction is constant. In other words, the elastic member 54 has a stepped shape defined by the increased thickness portion 5013, the connection portion 5023, and the decreased thickness portion 5033. A side surface of the connection portion 5023 which faces in the second direction is arranged to be in contact with a side surface of a reinforcing plate 512 which faces in the second direction. The reinforcing plate 512 is thus positioned in the second direction with respect to the beam portion 5112A. This arrangement also enables a stress to be distributed through the connection portion 5023.

Note that the connection portion having a constant thickness as described above may alternatively be defined by, for example, a portion of the reinforcing plate and a portion of the beam portion.

### 5. Fifth Preferred Embodiment

Next, a fifth preferred embodiment of the present invention will now be described below.

In the present preferred embodiment, an increased thickness portion and a decreased thickness portion are defined by the same member. An end portion of a beam portion on a side opposite to a joining portion is bent to approach a fixed surface in the first direction. This end portion is fixed to a surface of the beam portion on a side opposite to the fixed surface in the first direction. That is, the increased thickness portion is defined by a portion of the beam portion which includes the fixed surface, and the bent end portion of the beam portion. The portion which includes the fixed surface and the bent end portion of the beam portion are arranged opposite to each other in the first direction. In other words, the increased thickness portion is defined by the beam portion alone. A connection portion is defined between the increased thickness portion defined in the above-described manner and the decreased thickness portion by an application of an adhesive or the like. Note that the portion which includes the fixed surface and the bent end portion of the beam portion may be arranged to be in contact with each other in the first direction.

Thus, the need for a reinforcing plate to define the increased thickness portion is eliminated, and the number of steps for assembling a vibration motor according to the present preferred embodiment and the number of parts of the vibration motor can be reduced.

While preferred embodiments of the present invention have been described above, the preferred embodiments may be modified in various manners without departing from the scope and spirit of the present invention.

For example, the plate spring portion, the reinforcing plate, and the vibrator or the stationary portion may be fixed to one another not through welding but through adhesion using an adhesive. The weight may not be in the shape of a rectangular parallelepiped, but may be in the shape of a column, e.g., a round column, or in the shape of a tube, for example. It is desirable that the shape of an inside surface defining the cavity portion match an external shape of the weight.

Preferred embodiments of the present invention are applicable to vibration motors provided in electronic devices, such as, for example, smartphones or gamepads.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor comprising:
a stationary portion including a casing and a coil;
a vibrator including a magnet, and supported to be capable of vibrating in a first direction with respect to the stationary portion; and
an elastic member arranged between the stationary portion and the vibrator; wherein
the elastic member includes:
an increased thickness portion including a fixed surface fixed to one of the vibrator and the stationary portion;
a decreased thickness portion having a thickness smaller than that of the increased thickness portion as measured in the first direction; and
a connection portion arranged between the increased thickness portion and the decreased thickness portion in a second direction perpendicular to the first direction; and
the connection portion is arranged to have a thickness smaller than that of the increased thickness portion and greater than that of the decreased thickness portion.

2. The vibration motor according to claim 1, wherein
the elastic member includes a reinforcing plate and a plate spring portion including the fixed surface;
the increased thickness portion is made up of at least a portion of the plate spring portion and the reinforcing plate; and
the reinforcing plate is fixed to a surface of the plate spring portion on a side opposite to the fixed surface in the first direction.

3. The vibration motor according to claim 1, wherein a weld portion is defined in the vibrator and the increased thickness portion or in the stationary portion and the increased thickness portion.

4. The vibration motor according to claim 2, wherein a weld portion is defined to extend over the reinforcing plate, the plate spring portion, and the vibrator, or over the reinforcing plate, the plate spring portion, and the stationary portion.

5. The vibration motor according to claim 3, wherein
the elastic member has a first region adjacent to the weld portion in the second direction; and
the connection portion is arranged opposite to the first region in the first direction.

6. The vibration motor according to claim 4, wherein
the elastic member has a first region adjacent to the weld portion in the second direction; and
the connection portion is arranged opposite to the first region in the first direction.

7. The vibration motor according to claim 1, wherein the connection portion is arranged to decrease in a thickness with decreasing distance from the decreased thickness portion.

8. The vibration motor according to claim 1, wherein the connection portion includes an adhesive.

9. The vibration motor according to claim 1, wherein
the elastic member includes a plate spring portion; and
the connection portion is a portion of the plate spring portion.
